(19) United States
(12) Patent Application Publication
(10) Pub. No.: US 2009/0220060 A1
(43) Pub. Date: Sep. 3, 2009

(54) Phone and pin

(76) Inventor: Arnold Albert Wilson, London (GB)

Correspondence Address: MELANIE WAITE, 1390 CRESTWOOD DRIVE, REDLANDS, CA, 92373, US

(21) Appl. No.: 11/902,678

(22) Filed: Sep. 25, 2007

(51) Int. Cl. H04M 11/00

(52) U.S. Cl. 379/93.03

(57) ABSTRACT

1.1. Phone and PIN enables any unmodified telephone to act as a secure PIN (Personal Identification Number) entry means any remote Computer or Business Information System can use to authenticate the identity of any person or to obtain validation for any transaction purportedly made by any person.

There are many instances when Business Information Systems or individuals may wish to immediately confirm the accuracy, validity or authenticity of the identity of any person or confirm the accuracy, validity or authenticity of a transaction any person has, is about to or which they intend to present. This need often arises in the normal course of business and particularly when persons transact business on the Internet.

Phone and PIN provides an automated means for such authentication to be obtained.

The person to be called has a PIN number associated with their telephone, which is known to them.

The person is called on their telephone by the Phone and PIN System and requested by spoken automated means to enter their PIN onto their Phone to authenticate their identity or to obtain validation for any transaction purportedly made by that person.

Correct entry of the PIN typically provides such authentication.

The methodology to make this possible is described herein.

An example of how Phone and PIN can be used by way of illustration is included in the Appendix.

### 3.1. BACKGROUND AND GENERAL USE OF PHONE AND PIN

There are instances where it is desirable for a BIS to be able to obtain authentication of, verification of, or authorization of or for any Transaction from any person or to authenticate the identity of any person at any time. PIN verification is a simple but highly effective way to authenticate the identity of any person. One example of the use of PIN's is the use of a PIN as a method of authenticating a persons identity when said persons present Cards as a means of payment. The person presenting the card must enter the same PIN associated with the card to provide evidence that they are a bone fide card user before the transaction is processed. Phone and PIN provides an innovative means whereby any Phone can be used to request a PIN associated to the phone number of that phone as a means of authenticating any Transaction for such purposes as any BIS may require. The principal uses of this Invention are now outlined.

3.1.1. Fraud Prevention: When a BIS for any reason suspects that a Transaction was, is or may be fraudulent, incomplete or where any doubts over the authenticity of any aspect the Transaction are raised by any means by the BIS, the Invention can be used to determine the authenticity of that Transaction.

3.1.2. Transaction Confirmation: The BIS may wish to confirm something they believe to have occurred actually has occurred from their bone fide customer—for example the delivery or receipt of an item by or to a customer.

3.1.3. Transaction Authorization: The BIS may wish to obtain authorization from a known person to initiate, perform or complete any Transaction or request.

3.1.4. Proof of Identity: The BIS may wish to call any person on any Phone and request a PIN to obtain proof of the identity of the Call Recipient or other persons known to the Call Recipient.

3.1.5. General Enquiry: The BIS may wish to call person to make enquiries about any matter (e.g. to do a customer satisfaction survey) and obtain Responses concerning any matter as the BIS may require.

3.1.6. Feedback: In all instances, all or some of the Responses obtained from the Call can be fed back by the PAP System to the BIS.

3.2. Some Specific Applications of Phone and PIN

Specific applications of Phone and PIN include:
The prevention of all forms of Transaction fraud.
The prevention of all forms of Card fraud.
Obtaining proof of and authenticating a persons identity.
Obtaining confirmation that a Transaction has occurred from Call Recipients.
Obtaining proof a Transaction has been authorized by the Call Recipients.
Obtaining permission to perform a Transaction from the Call Recipients.
Warning Call Recipients that a Transaction is about to occur.
Requesting further information from a Call Recipient.

3.2.1. Phone and PIN as Means of Obtaining PIN's for Cards: Cards are a widely used means of authorizing payments to be made from the card holders account to that of the person they wish to pay. By means of this Invention a PIN may be associated with a Card but not encrypted on the card but stored remotely on the BIS or the BIS may use the PIN on the PAP Register for the purposes of authenticating any payment Transaction made on the card.

3.2.2. Card Fraud Prevention: In many instances Card Holder's accounts are defrauded in spite of fraud deterrents. Phone and PIN can be used to prevent Card fraud. For example, before a Card payment is made the BIS of the issuing bank or Card provider can use Phone and PIN to call the Phone of the Card account holder and request that the Card account holder authenticate any payment request by entering their PIN. By doing so before payment is made, fraudulent Transactions can be prevented. Doing so after payment is made enables fraud to be detected.

3.2.3. Card and Card Holder Both Present: When the Card Holder and the Card are physically present when payment is made using a Card (typically at a retail establishment) one current method of authenticating the payment is typically referred to as Chip and PIN. A PIN is stored on a micro chip embedded in the card is known to the Card Holder. There are instances when Chip and PIN cannot be used when the Card has such a PIN on it:
There is no Card PIN reader device available
The payment terminal cannot work due to hardware or software malfunction
the Card issuer prefers not to encode a PIN on the Card.

Phone and PIN provides an alternative or additional means of obtaining PIN verification of the payment from the card holder on their Phone.

3.2.4. Card Holder not Present: There are instances when a Card is used to make a payment but the person presenting the Card is not present—for instance; purchases made on the internet or by telephone.

If such a payment is initiated remotely and neither the Card Holder nor the Card are physically present at the location where payment is being made, it is not possible to put the Card being used into a Card Reader Device to obtain a PIN to authenticate the transaction.

This Invention provides the means whereby a PIN can be obtained in such instances to authenticate the payment Transaction.

3.2.5. No PIN Card Reader Present: The deployment of a Chip and PIN card reader infrastructure (as more fully described in section 3.2.3. above) can be prohibitive so no such reader device is present. This Invention provides an alternative means to obtain PIN authentication of the Card transaction.

3.3. Why SMS is Unsuitable as Means to Obtain PIN's: The advent of SMS (Short Messaging Service) or Texting technology is one method of obtaining a PIN after a transaction is presented for payment which does not accompany a PIN validation. This mechanism however is not feasible for this purpose because:
1. Many transactions require immediate authentication. Texting a PIN can be time consuming and transmission delays can occur from either sender or the responder making a real time validation extremely difficult to obtain.
2. A special phone is required that can send or receive SMS.
3. SMS requires the recipient initiates a response so once the message is sent so the sender losses control of the interchange.
4. There are many reasons why such an immediate response may not be possible.
5. SMS texts are stored on the sender's phone so unless the sender deletes these messages, loss or theft of the phone presents a real risk of their PIN being made known as it is stored or recorded on their phone.

As a result, SMS as a means of making or authenticating payments by PIN is limited in its capabilities.

3.4. The Phone and PIN Process Methodology

The Invention is a methodology that enables any Phone to function as a secure remote PIN entry device. FIG. 1 (below) provides an overview of the methodology of the Phone and PIN process, broken down into 10 steps that logically fall into 4 Stages.

3.5. Explanation of the 10 Steps

3.5.1. The BIS identifies instances within any Transaction where a Call would be advantageous.

The first step is for the BIS to identify instances where it would like to use Phone and PIN. Examples of possible applications of Phone and PIN are outlined in Sections 3.1. and 3.2. above.

3.5.2. An appropriate Call Template is created and the necessary call datum required to make the Call are identified These datum are used to create the Call Data Package (the Call Data). The Call Template may also include instructions for the Call Response Data Package (the Response Data) to be sent from the PAP System back to the BIS after the Call has been made.

Call Templates (as defined in 3.6.1. below) may be predetermined by the PAP System or be created and edited on Call Builder (as described in 3.6.2. below.) The Call Builder may specify the Call Data (as defined in 3.6.4. below) required to make the Call and the BIS can use it to determine what Response Data it requires back from the PAP System after the Call (as defined in 3.6.8. below) is made and the format they want that datum to be in.

3.5.3. The Triggering Event(s) within the Transaction for the Call are identified in the BIS and the procedure to create the associated Call Data when that Triggering Event occurs are encoded in the BIS.

Having determined the circumstances where the BIS would wish to make a Call, the BIS will then need to determine what the precise Triggering Event(s) (as defined in 3.6.3. below) is that will initiate the Call Process. This Trigger will be something that occurs in the course of a Transaction. The Call Data contains all the datum required by the PAP System to make the Call. The BIS may create specific programs to do this or use industry standard tools.

3.5.4. A Triggering Event occurs and initiates the Call Process: the BIS creates the Call Data.

Having created the Call Template and identified what events trigger the Call Process (as defined in 3.6.7. below), when a Triggering Event does occurs the Call Process is initiated. As part of that Call Process the BIS creates the Call Data to be passed to the PAP System to enable the Call to be made. The Call Data may or may not be encrypted.

3.5.5. The Call Data is passed to the PAP System.

This passage will be typically over a local or wide area network or via the internet or by whatever other means the BIS may decide. The data can be formatted and packaged in any way the BIS sees fit. It should be noted that the PAP System may be physically situated anywhere.

3.5.6. The Call Data is received by the PAP System and the Call Script is created.

The Call Data is received and will be decrypted if necessary. The Call Script (as defined in 3.6.5. below) is then created by the Controller (as defined in 3.9.9. below).

3.5.7. The Call Script is executed by the PAP System.

The Call Script is created and its execution managed by the Controller. The Controller causes the Call to be scheduled, queued, the Call delivered in accordance with the Call Script on the Platform (as defined in 3.9.8. and more fully in 3.10. below) by means of the Call Dialogue (as defined in 3.6.6. below).

3.5.8. The Call Response Data Package (Response Data) is created by the PAP System.

In accordance with the instructions in the Call Script, having made the Call, the Responses to the Call that are required by the BIS are packaged as Response Data in the form required by the BIS.

3.5.9. The Response Data is passed to the BIS.

In accordance with the instructions in the Call Script, the Response Data is passed back to the BIS over whatever transmission means the BIS and or the PAP System may determine.

3.5.10. The BIS receives the Response Data from the PAP System for processing

The Response Data contains the feedback the BIS requires from the PAP System. Typically, this will inform the BIS whether or not the PIN was input successfully and/or any other responses that they may require for their purposes. It will be noted that the PIN used to authenticate the identity of the call recipient may have been part of the Call Data or it may have been obtained by the PAP System from the PAP Register. If the PIN used in the Call Script was obtained from the PAP Register, the Call Data will have included a means of identifying the PIN to be used, typically the Phone number of the Call Recipient or a unique identifier for the Call Recipient in the PAP Register.

3.6. Definitions of terms applicable to the Process Methodology

3.6.1. Call Templates: Call Templates are created by the BIS to enable the BIS to use the PAP System to make Calls. The Call Template generally defines the structure and purpose of a Calls made by the PAP System to be made to specific Call Recipients as the result of a Triggering Event in the BIS. The use of Call Templates makes it possible for the PAP System to be flexible and for the Calls to match the specific Call requirements of the BIS in every instance of a Triggering Event. Templates can be created and/or edited using the Call Builder (see 3.6.2. below).

3.6.1.1. Template Content types: Call Templates may have any or all of he following:
Fixed Content (see section 3.6.1.2. below)
Variable Content (see section 3.6.1.3. below) or
Predefined Content (see section 3.6.1.4. below)

3.6.1.2. Fixed Call Template Content: These are the contents of the Call that are used in every instance a particular Call Template is used to make a Call.

For example, the Call Dialogues from the BIS of ABC Company may always include an introduction such as, “Hello, this is ABC Company calling”. This is an example of Fixed Content and this is spoken by the PAP System—in this example—every time a Call from that BIS is made. Another Fixed Content element may be that the Call is always delivered 10 minutes after the Triggering Event occurs.

3.6.1.3. Variable Call Template Content: This is content that can vary from one instance of making the Call to the next. An example would be the Phone Number of the Call Recipient Another might be a component in the Call Dialogue, such as the name of the person being called or the amount they may have spent in a purchase transaction.

In general the Variable Content is included in the Call Data.

3.6.1.4. Predefined Template: This is predefined template or template content which cannot be modified by the BIS.

3.6.2. Call Builder: This is a means of creating and editing Call Templates and to create and edit the actual content of the Call: this is the Call Dialogue. The Call Dialogue is the exchange that takes place between the PAP System and the Call Recipient during the Call. Call Dialogues can become complex structures. For instance, if a question is asked a number of different eventualities are possible and this can be difficult to visualize. It may be advantageous to graphically represent the required Call Dialogue and the Call Builder may provide a graphical user interface (GUI) for the creation of the Call Dialogues. The Call Builder may be specific to the hardware or software of the Platform (as described in 3.10. below) being used or a generic Call Builder tool.

The Call Builder enables any or all of the following to be achieved:
1. The creation and editing of the Call Dialogue used in the Call.
2. Determining the data required from the BIS to make the Call.
3. Determining the timing and frequency of the Call.
4. Determining the feedback to be obtained from the Call.
5. Determining what data has to be sent to the PAP System to make the Call.
5. Determining the format of the data sent to and received from the PAP System.
6. Any other aspect of the Call Templates content or control as may arise.

3.6.2.1. Where Call Templates are stored: Call templates can be either stored on the BIS or on the PAP System. If stored on the BIS, when the Call Data is compiled the Call Template will be included in the Call Data passed to the PAP System. Otherwise, the Call Template is stored on the PAP System and the Call Data will include the Call Template ID to identify the Call Template that is to be used to make the Call to be retrieved from the PAP System's Storage Means as described in 3.9.12. (below).

3.6.3. Triggering Event: Any Transaction or event the BIS chooses can initiate a Call. This is called a Triggering Event. Calls can be made for a purpose the BIS determines—for example to prevent fraud or confirm a person's identity. All industry standard data bases have the capability of creating such triggers and so provide all BIS's with complete freedom to determine precisely what constitutes a Triggering Event. Where such a capability does not exist on the BIS, processes to make this possible may need to be built into the BIS to enable it to do so.

3.6.3.1. Example of a Triggering Event: A Bank for instance may decide that every payment request that exceeds a predetermined monetary value in an individuals account will trigger a Call to the account holder asking them to confirm by PIN entry that they have authorized the payment.

3.6.4. Call Data Package (Call Data): This is all the data needed by the PAP System from the BIS to make the Call. The Triggering Event causes the Call Process to be initiated. Since every BIS is unique, it is impossible to ascertain what that process in total will involve. However, irrespective of the specific processes an individual BIS may see fit to invoke, in order for a Call to be made, that process will of necessity involve the creation of the Call Data.

Call Datum may include:
The Call Template or Template ID: this Template ID identifies the pre-designed Call Template if held on the PAP System to be used to make the Phone and PIN Call.
The Phone Number(s) to be called.
The PIN number in whole or in part, belonging to the Call Recipient that is to be checked as part of the Call.
A unique identifier for the PIN if the PIN used in the Call Template has to be obtained from the PAP Register
Dates
Amounts
Payee and payer names
The nature of the Transaction
Details of the Triggering Event.

3.6.5. The Call Script: A Call Script is the complete series of instructions used by the PAP System to enable it to control the entire life cycle of any Call. The Call Script is created by the PAP System from the Call Template. There are many different Automated Telephony hardware devices and associated software programs which are found on the Platform as described more fully in Section 3.10 (below). The Call Script enables the Call to be made on the specific Platform being employed by the PAP System.

3.6.6. The Call Dialogue: The Call Dialogue is the actual content of the exchange between the PAP System and the Call Recipient during the Call and more specifically refers to what the PAP System says to the Call Recipient. It is constructed by the Call Template and may use Call Data elements (e.g. the name of the BIS and/or the name of the Call Recipient, both of which were part of the Call Data sent to the PAP System). A typical Call Dialogue consists of a series of statements, questions and associated procedures and further statements, questions and logical procedures to be carried out until the Call Dialogue is completed. Call Dialogues are typically generated by industry standard Text To Speech (TTS) means as part of the telephony hardware or firmware used by the PAP System. These means are more fully described in Section 3.10. (below).

3.6.7. Call Process: The Call Process refers to all the necessary procedures to make and complete a Call from the point at which a triggering event has occurred to its completion. Any reference to the Call Process includes inter alia:
All Triggering events
All processes involved in the creation and transmission of Call Data to the PAP System.
All processes involved in Call delivery and completion by the PAP System.
All processes involved in obtaining Feedback from the PAP System concerning the outcome of the call and the means to deliver this feedback to any BIS.
All processes involved in processing feedback from the PAP System by any BIS.
Whatever other processes deemed necessary to enable the Call to be made.

3.6.8. Call Response Data Package (Response Data): This is the feedback of the Responses obtain as the result of a Call, passed back to the BIS, from the PAP System once the Call has been delivered, which the BIS may require. This Response Data is packaged in whatever format the BIS may determine and may also be encrypted.

3.7. The Phone and PIN System Components

With reference to the above methodology diagram, it can be seen that the software, hardware or firmware components required to facilitate the Phone and PIN Process Methodology can be conveniently classified as being either:
1. Components residing with the BIS. (as described in section 3.8. below)
2. All other Components—those components and process that form part of the PAP System. (as described in section 3.9. below) not residing on the BIS.

3.8. Components residing with the BIS

Where an existing hardware or software component that resides in the BIS is modified or used to perform a necessary process to enable the BIS to use the PAP System, such components are not to be regarded as part of the PAP System. However, the processes that such components perform specifically or any modifications made to existing BIS components specifically in order to enable the BIS to use the PAP System are to be regarded as part of this invention as they form part of the entire methodology.

Such components as are used or installed which were not already resident, in order for the BIS to use the PAP System are likewise to be regarded as part of the invention.

The components and processes that reside in the BIS that form part of the PAP System include the following:

3.8.1. Access to Call Builder: The BIS may have the means to access the Call Builder to enable the BIS to create, test and edit Call Templates that reside on the PAP System or which may be held on the BIS for onward delivery to the PAP System when Calls are triggered. The Call Builder may be a resident program of the BIS or it may be accessed remotely by the BIS.

3.8.2. The means to identify Triggering Events: The BIS will have the means whereby Triggering Events can be identified.

This can either be achieved:
1. using the existing capabilities of the BIS's resident systems,
2. by modifying the existing capabilities of the BIS's resident systems or,
3. by the addition of such software programs, algorithms or process compatible with the BIS's existing system to enable the BIS to identify said Triggering Events.

3.8.3. Creation means for the Call Data Package (Call Data): The BIS will have to have the means whereby once a Triggering Event has occurred, the Call Data can be created.

This can either be achieved,
1. using the existing capabilities of the BIS's resident systems,
2. by modifying the existing capabilities of the BIS's resident systems or,
3. by the addition of such software programs, algorithms or process compatible with the BIS's existing system to enable the BIS to create the Call Data, for example, by the addition of an API (Application Programming Interface) to the PAP System.

3.8.4. Delivery means for the Call Data: The BIS will have to have the means to deliver the Call Data to the PAP System which may or may not include the encryption of the Call Data.

This can either be achieved,
1. using the existing capabilities of the BIS's resident systems,
2. by modifying the existing capabilities of the BIS's resident systems or,
3. by the addition of such software programs, algorithms or process compatible with the BIS's existing system to enable the BIS to deliver the Call Data to the PAP System.

3.8.5. Reception means for the Call Response Data Package (Response Data): the BIS will have the means to receive the Response Data

This can either be achieved,
1. using the existing capabilities of the BIS's resident systems,
2. by modifying the existing capabilities of the BIS's resident systems or,
3. by the addition of such software programs, algorithms or process compatible with the BIS's existing system to enable the BIS to receive the Response Data.

3.8.6. Translation and or decryption means for the Response Data: the BIS will have the means to translate and or decrypt the Response Data into individual datum which the BIS can usefully process.

This can be achieved by:
1. using the existing capabilities of the BIS's resident systems,
2. by modifying the existing capabilities of the BIS's resident systems or,
3. by the addition of such software programs, algorithms or processes compatible with the BIS's existing system to enable the BIS to translate and or decrypt the Response Data into datum the BIS can usefully process.

3.9. All other Components: resident on, or accessed by the PAP System.

The PAP System comprises all the hardware, firmware, software and processes that are not resident on any BIS that are required to facilitate the Invention. These components may include the following means and any other means that may be necessary to enable the PAP System to perform its functions.

3.9.1. The means to receive Call Data: The PAP System will have the means to receive Call Data from BIS's. This may or may not require access to the BIS's network or connection to whatever transmission means as is necessary to be compatible with the BIS.

3.9.2. The means to translate and or decrypt Call Data: The PAP System will have the means to decrypt Call Datum received which are in an encrypted form.

3.9.3. The means to validate Call Data: The PAP System will have the means to check for the validity, completeness and accuracy of any Call Data to ensure it is bone fide Call Data and the means of sending such confirmations to the BIS of the acceptance and validity of the Call Data as the BIS may require.

3.9.4. The means to create Call Scripts from Call Data: The PAP System will have the means to use the datum contained in the Call Data to create Call Scripts and Call Dialogues.

3.9.5. The means to carry out the instructions contained in the Call Script: This is performed by the Controller (see 3.9.9. below) and includes the entirety of all remaining parts of the Call Process needed to complete any Call.

3.9.6. The means to Schedule Calls: The PAP System will have the means to schedule calls at any time per the instruction of the Call Script. This may be immediately or at any time in the future. This capability may or may not be part of the Platform.

3.9.7. The means to Queue Calls: The PAP System will have the means to queue and prioritize Calls for delivery.

3.9.8. The Platform: The PAP System will have the means to make Calls. These are made on the Platform (as described in 3.10 below).

3.9.9. The Controller: The Controller is the hardware and software means to control, synchronize and co-ordinate all the processes required to enable the PAP System to function. It may be noted that elements of this means may be physically removed from one another but nonetheless work in concert to achieve the purposes of the Invention.

The Controller encompasses all database and process management functions of the System and ensures all the processes and means to perform those processes as required by the PAP System operate in concert.

The Controller performs such tasks as ensuring Calls are made in accordance with the Call Script. This may involve delivery of Call Scripts and controlling Call Dialogues, depending on the particular specification of the PAP System.

If the PIN to be used in the Call Script is to be obtained from a PAP Register, the Controller obtains that PIN from the PAP Register.

The Controller may process responses obtained from Call Recipients by the Platform during Calls and pass back to the Platform the next part of the Call Dialogue based on those responses, otherwise this function is performed by the Call Platform.

3.9.10. The means to create the Response Data: Once calls have been made, the PAP System will have the means to create the Response Data which contains the feedback needed by the BIS to determine the outcome of the Call.

3.9.11. The means to deliver the Response Data: The PAP System will have the means to deliver the Response Data to the BIS which may include the encryption of the Response Data prior to delivery.

3.9.12. Storage Means: The PAP System will have a storage means whereby all Call requests and the outcomes of all Calls are stored including:
all Call Templates used to make Calls,
all aspects of the Calls made,
all details of all Calls attempted or made, their course and duration,
all responses obtained,
all Call Data received,
all Response Data delivered,
all Call Scripts used,
the means to retrieve and process such datum as are stored in the Storage Means.

3.9.13. The means to access the PAP Register: If the BIS uses the PAP Register as the means of obtaining the PIN of the Call Recipient, the PAP System will have the means to access the PAP Register.

3.10. The Platform (or Call Platform or the Call Delivery Means).

The Platform is the component of the PAP System that provides the Call Delivery Means whereby Calls are made to Call Recipients and responses from the Call Recipients are obtained in accordance with the Call Script.

The Platform comprises industry standard software and hardware components and many such Platforms exist and can be can be obtained in whole or constructed from separate parts. Such Platforms may be modified as necessary to enable it to perform the functions described herein.

The Platform receives in whole or in part, instructions from the Controller in whatever format the Platform requires in order for it to perform the processes outlined in this Section.

The Platform possesses the following capabilities:
1. The means of Delivering the Call Dialogue.
2. Speech Generation Means.
3. Response Recognition Means.
4. The means to process Responses.
5. Other capabilities.

3.10.1. The Means of Delivering the Call Dialogue: The Call Dialogue is typically presented to the Platform in a structured VXML (Voice XML) script or any other similar industry standard format or in whatever format the Platform requires to carry out the instructions contained in the Call Script. This will involve the PAP System speaking to the call Recipient and obtaining responses from the Call Recipient. The Platform will therefore require a Speech Generation means and a Response Recognition means.

3.10.2. Speech Generation Means: The Platform will have the Hardware and Software necessary to deliver spoken parts of the Call Dialogue to the Call Recipient and these are the Speech Generation Means. The Speech Generation Means includes:
1. Converting text received from the Control Means as part of any Call Dialogue presented in the prescribed manner to the Platform using a Text To Speech means, or
2. By the delivery of pre-recorded speech segments in whole sentences, words or syllables in whole or in part, or
3. By a combination of 1. and 2.

3.10.3. Response Recognition Means: The Platform will have the Hardware and Software necessary to obtain, recognize and record responses given by the Call Recipient in the course of the delivery of the Call Dialogue. These are the Response Recognition Means. The Response Recognition Means includes:
1. Voice Recognition Means using industry standard Voice Recognition technology, or
2. Recognition of alpha-numeric inputs made by the Call Recipient on their Phone key pad or entry pad or input by any means other that by Voice Recognition, or
3. By a combination of 1. and 2.

3.10.4. The means to process Responses: When responses are made by the Call Recipient in the course of the Call Dialogue, the Platform will have the means to further process these Responses as appropriate. For example this may include checking the validity of any given Response against an expected Response and then delivering the next part of the Call Dialogue as described in the Call Script, based on the Call Recipients Response. The Platform may also perform logic tasks as part of this process. For example to compare any inputted Call Recipients Response with an expected value or using the response given to initiate the next part of the Call Dialogue as required by the Call Script. This function may or may not be performed by the Platform itself or it may be performed by the Controller which may then issue to the Platform the next part of the Call Dialogue to be delivered. By this means the Call Dialogue as described in the Call Script can be completed and all the responses required from the Call Recipient can be obtained.

3.10.5. Other capabilities: Platforms used in this Invention will be made from industry standard components and they possess numerous capabilities not specifically described herein as being necessary to enable the Invention to function. However, this does not preclude the possibility of those capabilities and functions being incorporated within the Call Script and used advantageously by the PAP System. For example the ability of some Platforms to “Bridge” calls. Call Bridging occurs when the PAP System transfers a call being made to a Call Recipient to another phone number. For instance, the PAP System may cease speaking to the call recipient and pass the call over to a human person or another computerized or automated system to continue the Call.

3.10.6. The Phone and PIN Register: The PAP Register may form part of the Platform.

3.10.7. Overview of the Platforms functions.
It receives instructions from the Controller in the form the Platform requires enabling it to make the Calls.
It makes the Calls to the Call Recipients.
It delivers the Call Dialogue to the Call Recipient.
It obtains the responses from the Call Recipients.
It performs such processes on the responses obtained from the Call Recipients as the Call Script describes.
It stores those responses.
It feeds back the responses and any other datum generated as a result of the Call as required by the Call Script to the Controller in such form that the Controller may require.

### APPENDIX

This is an example of typical Phone and PIN Call purely by way of illustration. This does not form part of the Invention.

A.1.1. The Triggering Event: A Transaction has been presented to the Bank of an account holder (who will be the Call Recipient) for payment. The bank's BIS has identified the Transaction as a Triggering Event warranting a Call. In this example the amount that has been requested to be paid has exceeded a predetermined value limit—this is the Triggering Event.

The Call Process is initiated by the Bank's BIS and the Call Data assembled.

The Call Data is passed to the PAP System.

In this instance the Call Data includes the customers name, telephone number, PIN (which was stored on the BIS), the name of the payee and the amount of the Transaction.

The PAP System picks up the Call Data. The Call Template to be used to make the Call is specified in the Call Data and located in the PAP System. The other data in the Call Data is combined with the Call Template to create the Call Script.

The Call Script is executed.

A.1.2. The Call Dialogue.

The Call Recipient's telephone number (in this instance the Call recipient is the Banks customer) is called by the Platform. This number was included in the Call Data as was their PIN.

The Call recipient answers the call.

The Call Dialogue is as follows: all spoken parts are in italics.

Call Recipient: [speaks]: Hello?

PAP System: [detects spoken response and initiates spoken dialogue as follows]: Hello Mr. Smith. This is the National Bank calling you to ask you to confirm a transaction you have just made. A payment for $250 has been requested by Acme Paint Corporation. To accept this, please enter your PIN after the tone or press the star key to repeat this message. [Pause, then a BLEEP tone sounds]

Call Recipient: [enters his PIN on his phone keypad]

[The PAP System compares the PIN entered by the Call Recipient with the PIN presented by the Bank to the PAP System in the Call Data. If the PIN entered by the Call Recipient does not match that received by the PAP System from the bank—i.e. the PIN is incorrect—the PAP System offers the Call Recipient the option to try again. This part of the Dialogue has been excluded. If the Call Recipient cannot input a matching PIN after 2 further attempts the Call is terminated and the PAP System will pass back a “Fail” response to the Bank in the Response Data. Let us assume in this example that the PIN entered by the Call Recipient is correct and a “Pass” response is recorded by the PAP System.].

PAP System: Thank you Mr. Smith, your PIN was correct. You have accepted this transaction Thank you for using the National Bank Goodbye. [Call terminates.].

A.1.3. Completion of the Call Process: It should be noted that Mr. Smith may at any time during the call, enter his PIN and he may even terminate the call after doing so immediately. This is called Call Barging. By this means the entire process can take only a few seconds to complete.

In this example the “Pass” Response obtained from the Call Recipient by the PAP System is packaged into the Response Data. This may be encrypted.

The Response Data is passed back from the PAP System to the Banks BIS which then processes the “Pass” response. In this instance, the Transaction to pay $250 from the Customer account to Acme Paint Corporation is completed and the authorization for it from the customer noted.

The Call Process is complete.

1. 2.1. Phone and PIN (or “Phone and PIN” or the “Invention” as defined in 2.2.1. below) is
a process and methodology by which any Business Information System (or “BIS” as defined in 2.2.6. below)
can make an automated call (or “Call” as defined in 2.2.4. below)
as the result of any Transaction (as defined in 2.2.8 below)
by any person or Call Recipient (as defined in 2.2.9. below)
to any telephone (or “Phone” as defined in 2.2.3. below)
using the Phone and PIN System (or “PAP System” as defined in 2.22.),
to deliver a message in the form of an interactive dialogue (or “Call Dialogue” as defined in 2.2.10. below) and as part of that Call Dialogue may
request a Personal Identification Number (or “PIN” as defined in 2.2.7. below) to be input by the Call Recipient on their phone by keypad entry or spoken means
the PIN used to verify any Transaction may be provided in whole or part by the BIS or
the PIN used to verify any Transaction may be obtained from a Phone and PIN Register (or “PAP Register” as defined in 2.2.12 below)
the completeness, accuracy and validity of the PIN obtained from the Call Recipient can be determined
the completeness, accuracy and validity of any other responses made by the Call Recipient to requests made (or “Responses” as defined in 2.2.5. below) by the Call Recipient in the course of the Call can be determined and stored and that
these Responses—which may include the determination of the accuracy, completeness and validity of the request for a PIN from the Call Recipient—can be reported back by the PAP System to the BIS
in order that any prior, current or intended Transaction can be authenticated for any purpose of the BIS.
2.2. Definitions for the Purposes of the Claims
2.2.1. Phone and PIN or the Invention: The entire invention, the processes and methodology that constitute the innovation as described herein. The process and methodology embodied in this Invention are described in detail in Section 3.4 (below) and the suggested components to facilitate this process and methodology are described in Sections 3.7., 3.8. and 3.9 (below). This invention includes the creation of the PAP Register (as defined in 2.2.12 below) which forms part of the entire invention.
2.2.2. The PAP System: All the components of the Invention either reside on the BIS (as defined in 2.2.6. below and as more fully described in 3.8 below) elsewhere and form the PAP System (as more fully described in 3.9 below)
2.2.3. Phone: A Phone is any device that is used by a Call Recipient to authenticate any Transaction by the means of this Invention. A Phone is typically a telephone with a phone number associated with it that may be called via any public telephone network or on a private network, including, but not exclusively, a landline Phone, a mobile or cellular Phone or any Phone that uses the internet as a connection means to any other telephone network that can be called using a telephone number.
2.2.4. Call: When the PAP System makes an outbound phone call to any Phone it is a Call.
2.2.5. Response: A Response is any response given by the Call Recipient to a Call which is recognized and then recorded as datum in any form by the PAP System and which meaningfully reflects a response given by the Call Recipient to any question or request made by the PAP System in the course of the Call. This Response can be stored and/or passed onto the BIS on whose behalf the Call was made. Responses are recognized and recorded as more fully described in Section 3.10.3. (below).
2.2.6. BIS: Business Information System or BIS includes the computerized hardware and software system of any person or business. For the purposes of this invention the BIS is also deemed to include the persons who operate or control the BIS.
2.2.7. PIN: A PIN is a Personal Identification Number of indeterminate length that is used as a means of providing proof of a persons identity to another party. PIN's are used widely for this purpose in a variety of ways. A PIN can be encrypted on a microprocessor embedded on a credit or debit card (or Card as described more fully below in section 2.2.13). This PIN is known to the bone fide user of the card (or Card Holder as more fully described in section 2.2.14 below). When the card is presented for payment at a suitable terminal, the PIN stored on the card is decrypted and the transaction is approved only when the card holder enters the same PIN on the terminal as is stored on the card. With Phone and PIN, the PIN number associated with the Call Recipients phone number is stored remotely, typically on the PAP Register (as described more fully in section 2.2.12 below) or on the BIS and not on the Phone. When any Transaction triggers a Call, the Call Recipient is asked to confirm the authenticity of the Transaction by entering his PIN, known to the Call Recipient The identity of the Call Recipient and an infinite variety of Transactions can therefore be authenticated by this Invention. For the purposes of this Invention a PIN is any alpha-numeric string of any length that can be presented to the PAP System from any Phone on any telephone key pad or telephone number entry mechanism or by any other means, including any spoken means.
2.2.8. Transaction: BIS's process information, complete transactions, trigger internal processes or events, trigger external processes or events, give persons access to information or pass information to other BIS's or persons. Such systems may or may not be accessible via the internet or by other automated or electronic means. All such processes and events that the BIS has, does or may carry out as part of its business are hereinafter known as Transactions. For example: a payment request from a retailer to a Credit Card Company is a Transaction, which involves numerous separate processes and events. A person requesting access to a bank account via the Internet is a Transaction. For the purposes of this invention a Transaction includes any event of any kind that:
1. Has occurred in the past
2. Is occurring in the present.
3. One which may or may not occur in the future.
2.2.8.1. For the purposes of this Invention proving the authenticity of a persons identity is also a Transaction.
2.2.8.2. For the purposes of this Invention attempting to gain access or requesting permission to gain to any location is also a Transaction. This location can exist as a physical location or be a virtual location such as an Internet site.
2.2.9. Call Recipient: Any person any BIS wishes to call using the PAP System is the Call Recipient. A Call Recipient would typically be a prospective or actual customer, account holder, supplier or employee of any BIS or any person connected to the BIS in any way involved in a Transaction.
2.2.10. Call Dialogue: When the PAP System calls a Call recipient, the PAP System engages in an interactive exchange that consists of statements, questions and PIN requests delivered by the PAP System to which the Call recipient can or may respond. The Call Dialogue refers to the entire content of this interchange between the PAP System and the Call Recipient. The Call Dialogue is more fully described in 3.6.6. (below).
2.2.11. Phone and PIN Call Dialogue: When the PAP System Calls a Call recipient, the PAP System engages in an interactive exchange that consists of statements and questions delivered by the PAP System to which the Call recipient can or may respond by keypad entry or spoken means. The Call Dialogue describes the entire possible content of this exchange. The Call Dialogue is more fully described in 3.6.6. (below).
2.2.12. Phone and PIN Register (AP Register): The PAP Register is a secure listing of Phone numbers and their associated PIN numbers.
2.2.12.1. A PAP Register may be made available to any BIS to enable them to use the PAP System to authenticate any Transaction from any Call Recipient on any Device.
2.2.12.2. Any or all of the Phone Numbers of any or all Phones in any or all regions may be listed on a PAP Register. This PAP Register may be used by any BIS independently of the other components of the PAP System. Use of this register for any purpose by any means on any Device by any BIS constitutes the use of the entire Invention.
2.2.12.3. All Phone numbers and their PIN's on a PAP Register may also be allocated a unique identification number.
2.2.12.4. A PAP Register has the advantage of enabling the Call Recipient to have one PIN associated with their Phone Number that can be used to authenticate Transactions made by them with multiple BIS's.
2.2.12.5. Only the bone fide user of the Phone Number on the PAP Register may access the Register to determine what the PIN allocated to that Phone Number is or to change that PIN to such number as the bone fide user of that number may determine.
2.2.12.6. The access means to any PAP Register may be determined in any way the provider of any such PAP Register sees fit.
2.2.12.7. The pre-allocation of PIN's to Phone Numbers on a PAP Register guarantees the completeness and accuracy of all such Phone numbers and their associated PIN.
2.2.12.8. The pre-allocation of PIN's to Phone Numbers on a PAP Register simplifies and speeds up the allocation of PIN's to prospective Call Recipients by any BIS and this can be achieved by whatever means the provider of the PAP Register may see fit.
2.2.12.9. The creation of any such PAP Register forms part of this invention.
2.2.12.10. Any Personal Details of the bone fide user of any Phone Number my also be associated to the PAP Register, such as the Phone Number users name, address, date of birth, credit and debit card numbers, account numbers or social security numbers etc. These Personal Details therefore also can be authenticated by the PAP System.
2.2.12.11. The provider of a PAP Register may also use any commercially available means to determine whether the bone fide user of any Phone Number on a PAP Register has knowledge of the PIN number associated with their Phone Number, on a PAP Register.
2.2.13. Card: A Card is any debit, credit or payment card, typically plastic, used as a means of effecting payment from one person to another by various payment means. The Card typically has full details of the Card Holder's (see 2.2.14 below) account number on it, such details may be displayed and/or encoded on the card in some fashion, typically on magnetic strip or microprocessor embedded in the card. The card may have various security features which may include have a PIN known by the Card Holder encoded on the card by some means, typically on an embedded microprocessor or on the magnetic strip.
.062.2.14. Card Holder: The Card Holder is the bone fide user of any Card who may or may not be the person identified on the Card but who nonetheless may legitimately use the Card.
